(19) United States
(12) Patent Application Publication
(10) Pub. No.: US 2007/0214081 A1
(43) Pub. Date: Sep. 13, 2007

(54) Method, Apparatus, and Computer Readable Medium for Providing a Stream of Payments

(76) Inventor: Leslie L. Jacobs JR., Bethesda, MD (US)

Correspondence Address: Michael N Haynes, 1341 Huntersfield Close, Keswick, VA, 22947, US

(21) Appl. No.: 10/583,222

(22) PCT Filed: Dec. 31, 2004
(86) PCT No.: PCT/US04/43856

§ 371 Date: Mar. 19, 2007

Related U.S. Application Data
(60) Provisional application No. 60/533,249, filed on Dec. 31, 2003.

(51) Int. Cl. G06Q 40/00

(52) U.S. Cl. 705/40

(57) ABSTRACT

A method, computer readable medium, and apparatus for providing a more consistent stream of aggregate payments that are to satisfy a plurality of obligations to receive payments in exchange for transfers of interests in one or more intellectual property assets.

### CROSS-REFERENCE TO RELATED APPLICATIONS

This application claims priority to, and incorporates by reference herein in its entirety, pending U.S. Provisional Patent Application Ser. No. 60/533,249 (Docket No. BMP-4A), filed 31 Dec. 2003.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 depicts a variable stream of payments that are to satisfy a plurality of rights to receive payments (and/or obligations to provide payments) in exchange for transfers of interests in one or more intellectual property assets.

FIG. 2A depicts multiple variable streams of payments that are to satisfy rights to receive payments in exchange for transfers of interests in one or more intellectual property assets. The multiple variable streams of payments extend over several time periods.

FIG. 2B depicts a table showing the amount of the payment(s) associated with each of the multiple variable streams of payments shown in FIG. 2A for each time period.

FIG. 3 shows, for each time period, the total aggregate amount of payments associated with different possible combinations (without repetition) of segments of the multiple variable streams of payments identified in connection with FIGS. 2A and 2B. For each period of time, the total aggregate payments, which correspond to a combination of segments of the multiple variable streams of payments, and which satisfy certain criteria, are selected and are circled in FIG. 3.

FIG. 4 shows the steps of a method which may be computer implemented.

FIG. 5 provides a block diagram of an exemplary embodiment of a system 5000.

FIG. 6 provides a block diagram of an exemplary embodiment of an information device 6000.

### DETAILED DESCRIPTION

Intellectual property asset interest holders (e.g., owners and licensees) are presently seeking to exploit their intellectual property assets to a much greater extent than in the past. The exploitation of intellectual property assets has lead to an increase in revenues for these intellectual property asset interest holders that is based on the licensing, sale, leasing, and/or infringement of those intellectual property assets. By way of example, the licensing of intellectual property assets can provide an intellectual property asset interest holder with a right (e.g., a contractual right, statutory right, common law right, and/or equitable right, etc.) to receive a future stream of royalty payments (and/or conversely, can provide another party (e.g., a counter-party, licensee, debtor, and/or infringer, etc.) with an obligation to provide payments), which can be based on the sales of products and/or services incorporating the intellectual property asset(s). These royalty payments often extend over time and end in accordance with the terms of the license agreement upon which the royalty payments are based. An intellectual property asset interest holder might also seek to sell and/or lease intellectual property rights to another entity in return for a stream of fixed or variable payments. Similarly, an intellectual property asset interest holder might obtain a judgment against, and/or a settlement with, an accused infringer, satisfaction of which might be divided into a stream of fixed or variable payments.

An entity (such as a licensor, lessor, and/or seller) having a right to receive future payments flowing from another entity's use of an intellectual property asset could be left with the prospect of having to wait for those future payments. An intellectual property asset interest holder may desire to receive a present cash payment instead of waiting to receive future payments. By way of example, the present cash payment could correspond to the net present value of the future stream of payments (e.g., royalty payments). By receiving a present cash payment, the business entity could reinvest the money in its core business to potentially achieve a higher rate of return.

The use of intellectual property (IP) based asset-backed securities can permit the conversion of a stream of income associated with an intellectual property asset into a cash payment or some other form of compensation, such as via the grant of an interest in other assets (intangible or tangible). The compensation may represent a value, such as the net present value, of that stream of income (possibly less any transaction fees associated with the issuance of those IP based asset-backed securities).

As to the issuance of IP based asset-backed securities, it is important to note that the income generated by intellectual property assets is usually a function of a future stream of royalty payments, as is the case with the licensing of an intellectual property asset. Notwithstanding the variability generally associated with royalty payments, the financial community has increasingly recognized the value that can be associated with intellectual property assets and has taken steps to harness this value through the use of IP-based asset backed securities.

Traditionally, asset backed securities have relied upon assets, such as credit card debt and mortgages, that are tied to a relatively predictable income stream. Because the delinquencies associated with both unsecured and secured debt are often very predictable, the expected rate of return on investments associated with these securities often can be accurately determined.

Investments associated with intellectual property assets can involve not only substantial legal risk but also substantial commercial risk. Hence, if one seeks to convert a right to receive a future stream of royalty payments into a single cash payment, one might need to find investors who are willing to shoulder the legal and commercial risks associated with the intellectual property asset underlying that stream of royalty payments.

Thus, it can be desirable to discover techniques for reducing the variability associated with streams of, for example, royalty payments so that they are more consistent and so that they will provide a more predictable cash flow to enable investors in asset backed securities, as well as other investment vehicles, with a greater degree of confidence that the income associated with the asset backed securities will be more reliable.

Certain exemplary embodiments encompass techniques that provide for a more consistent stream of aggregate payments that are to satisfy a plurality of obligation(s) to provide payments to a holder of one or more rights to receive those payments in exchange for transfers of interests in one or more intellectual property assets and can be understood with reference to the description presented below and associated claims. Certain exemplary embodiments can generally be embodied in a method, computer readable medium, and/or apparatus, etc.

Certain exemplary embodiments relate to a method, computer readable medium, and/or apparatus for providing a more consistent stream of aggregate payments that are used to satisfy obligation(s) to provide payments to a holder of one or more rights to receive payments in exchange for transfers of interests in one or more intellectual property assets. By way of example, the intellectual property assets may include patents, patent applications, copyrights, trademarks, and/or trade secrets, etc. The transfers of interests in intellectual property assets might arise as a result of different transactions including the licensing, sale, and/or leasing of those intellectual property assets.

In accordance with one exemplary embodiment, a method is provided that comprises the act of selecting one or more segments of multiple expected streams of payments that are to satisfy rights to receive payments in exchange for transfers of interests in one or more intellectual property assets. Each segment can represent a portion of one stream of payments, that portion being less than the entirety of the stream. The segments may correspond to a first time period having a first duration that is less than a second duration of a second time period over which at least one of the expected streams of payments is expected to extend.

The segments can be selected such that a first total amount of payments associated with the segments satisfies one or more criteria. By way of example, the criteria can comprise a requirement that the first total amount of expected payments exceed a predetermined amount in the first time period. The criteria can comprise a requirement that the first total amount of expected payments be closest to the predetermined amount relative to a second total amount of expected payment. The criteria can comprise a requirement that the first total amount of expected payments fall within a predetermined range of expected payments to be received in the first time period.

The method can comprise selecting multiple segments of the multiple expected streams of payments from a multiple time periods including the first time period. Each of the multiple time periods can correspond to at least one of the multiple segments.

The method can comprise the act of identifying one or more portions of right(s) for transfer to an entity. These portions can correspond to the one or more segments that correspond to the first time period. These portions can be identified for transfer apart from at least one remaining portion of at least one of the plurality of rights.

The method can comprise identifying multiple portions of rights for later transfer to an entity, such as a special purpose vehicle that facilitates an issuance of securities backed by said one or more portions of one or more of said plurality of rights. These portions can correspond to the multiple segments and may be identified for transfer apart from at least one remaining portion of at least one of the rights.

If an exemplary embodiment is employed to identify multiple portions of rights that are to be transferred to a special purpose vehicle, it might be useful to investment bankers who traffic in IP-based securities, such as the Pullman Group headed by David Pullman. David Pullman has sold bonds which have been backed by the licensing royalties associated with David Bowie's catalog of copyrighted music. The licensing royalties associated with album sales are a function an artist's copyright interest in the songs appearing on the album. A more detailed analysis of the transaction involving the Bowie bonds can be found in an article entitled, “Bowie Bonds Sold for Far More than a Song: The Securitization of Intellectual Property as a Super-Charged Vehicle for High Technology Financing”, Santa Clara Computer and High Technology Law Journal, Vol. 15, No. 1, January 1999.

The issuance of IP-based asset backed securities can involve several steps. Initially a special purpose vehicle can be established. The special purpose vehicle can be a partnership (limited or general), corporation, limited liability partnership, limited liability company, and/or Delaware Intellectual Property Holding Company, etc. Once the special purpose vehicle is established, the assets that will ultimately back the IP-based asset backed securities can be transferred to the special purpose vehicle to facilitate the issuance of those securities. In particular, the assets can be sold to the special purpose vehicle so that the special purpose vehicle may issue those securities. The assets, which can be transferred to the special purpose vehicle, can include one or more rights to receive royalties from the sale of goods and/or services that incorporate one or more intellectual property assets. These assets also can comprise one or more rights to receive payments associated with the sale or leasing of one or more intellectual property assets. The assets can comprise a security interest in one or more of the intellectual property assets, a transferable interest in each of which has been exchanged for the rights.

One reason for setting up the special purpose vehicle can be to isolate the assets from any credit problems of the originator, which in this instance can be the entity acquiring the right to receive a stream of future payments from, for example, a licensor, lessor, and/or seller, etc., of intellectual property assets. In this regard, the special purpose vehicle can secure a perfected security interest in the assets that are transferred to the special purpose vehicle. This security interest can protect the assets, and hence the ultimate purchasers of the asset backed securities, from the reach of creditors if the originator itself faces the prospect of bankruptcy.

After a security interest has been perfected in the transferred assets, and if necessary and/or desired the underlying intellectual property assets, the special purpose vehicle can issue securities (i.e., the IP-based asset backed securities) in the manner prescribed by law. Thereafter, the assets can be serviced to ensure that the securities holders are properly compensated.

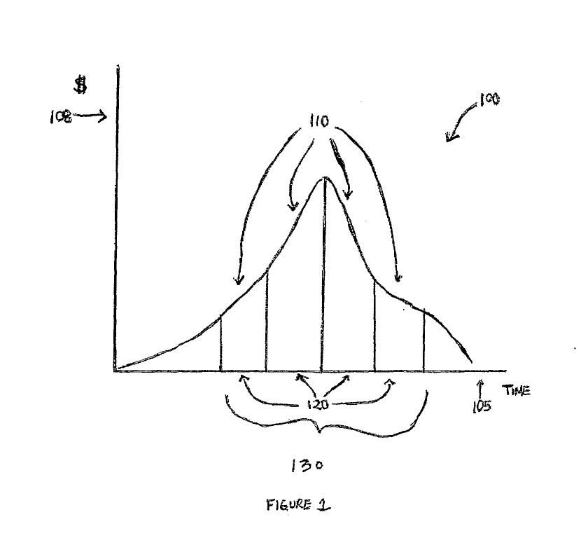

FIG. 1 depicts a variable stream of expected payments 100, such as royalty payments, that are to satisfy a plurality of rights to receive payments in exchange for transfers of interests in one or more intellectual property assets. The horizontal axis 105 reflects the passage of time, whereas the vertical axis 108 reflects expected payments. The variable stream of expected payments can be modeled using a number of different modeling schemes. By way of example, it might be useful to employ the Gaussian (Normal) Probability Distribution Function because such a function might roughly approximate a shape reflecting a life cycle of products or services incorporating the intellectual property in which a transferable interest was exchanged for the rights to receive payments. However, those skilled in the art will appreciate that other such functions may be used to model a stream of expected payments, including a linear function, a quadratic function, or a logarithmic function. The variable stream of expected payments has been parsed into a number of segments 110 corresponding to periods 120 falling within a larger time period 130 of interest.

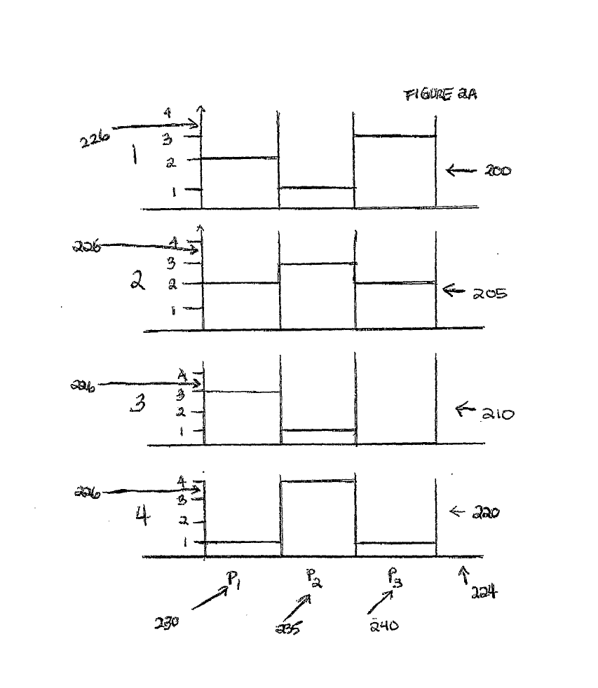

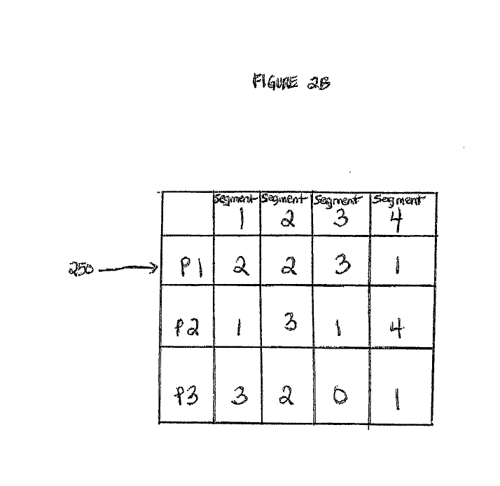

FIG. 2A depicts exemplary multiple variable streams of payments 200, 205, 210 and 220 that are to satisfy rights to receive payments in exchange for transfers of interests in one or more intellectual property assets. The horizontal axis 224 reflects the passage of time, whereas the vertical axis 226 reflects expected payments. The multiple variable streams of payments extend over three time periods 230, 235 and 240. Each period shown on the horizontal axis 224 is one unit (e.g., one month, one quarter, or one year, etc.), but any period can be used. In addition, the amounts shown on the vertical axis 226 are in millions of dollars, however any currency and/or monetary scale can be used. The shapes of the variable streams of payments are chosen simply to facilitate an understanding of this embodiment, and it is contemplated that they could have a variety of shapes. The area under the curve shown representing each of the multiple variable streams of payments 200, 205, 210 and 220 for any given period can correspond to the expected amount of payments to be received in that period.

FIG. 2B depicts a table 250 showing the amount of the payment(s) associated with segments of each of the multiple variable streams of payments shown in FIG. 2A for each time period. Each segment represents a portion of one stream of payments, that portion being less than the entirety of the stream.

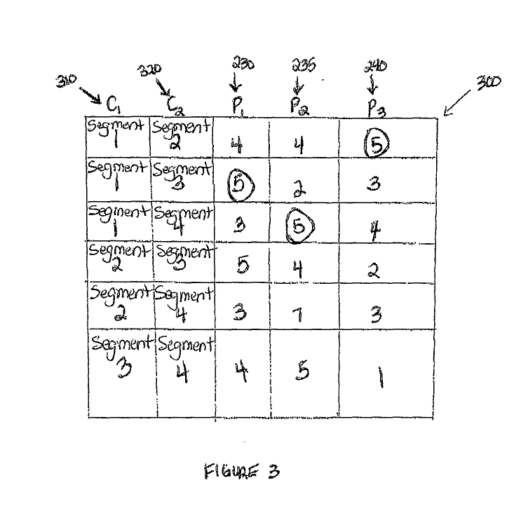

FIG. 3 shows in a table 300, for each time period 230, 235 and 240, the total aggregate amount of payments associated with different possible combinations (without repetition) of segments of the multiple variable streams of payments identified in connection with FIGS. 2A and 2B. Here C₁ 310 and C₂ 320 reflect two segments selected from among four possible segments in each time period 230, 235 and 240. If we have four segments and wish to select only two, the number of combinations to be evaluated can be determined using the following formula: n_C_k=n!/(k!(n−k)!). In this example, n=4 and k=2. As such, there are six possible combinations to evaluate for each time period. However, the actual values of n and k may vary as desired.

For each period of time, the total aggregate payments that correspond to each combination of segments of the multiple variable streams of payments can be determined. If the total aggregate payments for a particular period satisfy certain criteria specified, for example, by a user of an exemplary method, then the corresponding combination of segments can be determined to satisfy the criteria, and they can be selected. In this example, the criteria can comprise one or more of the exemplary requirements that follow: the combination of segments to be selected (i) must provide total aggregate payments of at least a predetermined amount of $5 million and (ii) must provide total aggregate payments that are closest to the predetermined amount. In the event that there is a tie among the total aggregate payments provided by two or more combinations of segments, the first of these combinations to be evaluated is selected. Those combinations of segments selected for each of the periods 230, 235 and 240 are shown circled in FIG. 3. Thereafter, portions of right(s) that correspond to the selected segments are identified for transfer to an entity, such as a special purpose vehicle, as indicated above.

Those portions of right(s) which correspond to non-selected segments may be used for other purposes. By way of example, they may be held in reserve to guarantee interest and principal payments made by the entity (e.g., a special purpose vehicle). Alternatively, those portions of right(s) which correspond to non-selected segments may be made available for transfer to another entity (e.g., a special purpose vehicle).

Certain exemplary embodiments can be implemented in a computer system including one or more computers, which may be connected via a network (not shown). Certain exemplary embodiments can be implemented in a computer readable medium of the type described below. Each such computer can be a desktop, laptop, PDA, cellular phone, and/or other such device. The computer can be provided with a communication interface for two-way communication that provides the computer with a physical and/or wireless network connection. The communication interface can be coupled to a processor via one or more buses. Examples of communication interfaces include a modem (analog or digital), LAN card, and/or an ISDN card, etc.

The communication interface can provide a link to one or more networks. By way of example, the communication interface can enable a connection to a remote computer via, for example, equipment operated by an Internet Service Provider. The Internet Service Provider in turn can provide data communication services through the worldwide packet data communication network referred to as the Internet.

Each computer can comprise one or more processors for processing information that is coupled to one or more memory storage devices via one or more buses. The memory storage devices can be used for storing information and/or instructions to be executed by the processor(s). The memory storage devices can include dynamic storage device(s) and/or static storage device(s).

Examples of such memory storage devices include a RAM, ROM, flash memory, magnetic disk, optical disk, and/or a redundant array of independent drives (RAID), etc. The computer can be coupled to the storage device(s) via a local area network, wide area network, and/or public network (e.g., the Internet).

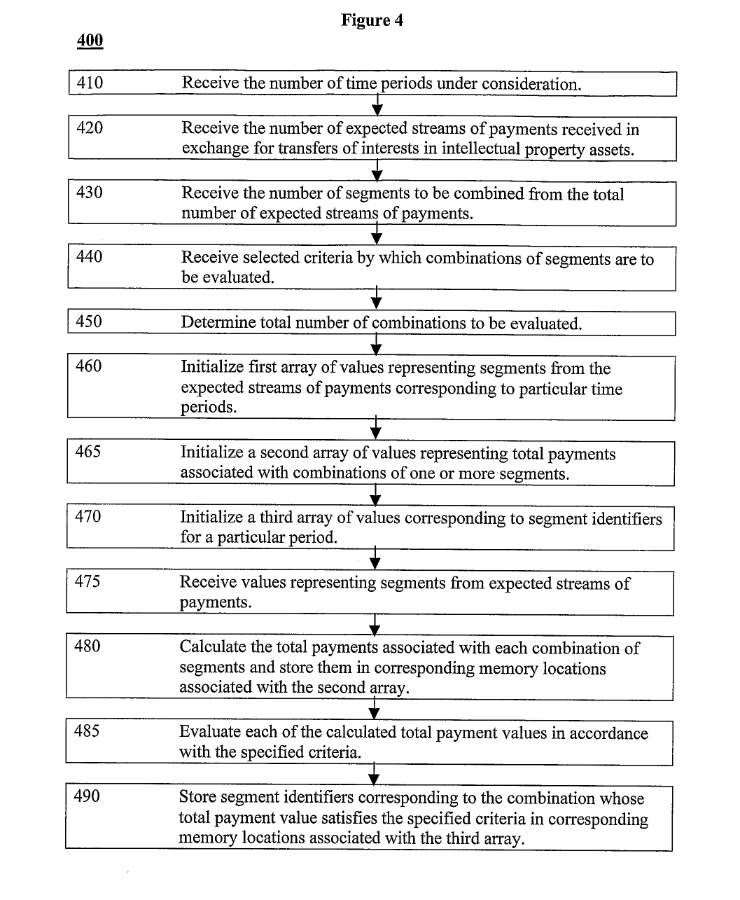

The memory storage device(s) coupled to the processor(s) of the computer can store programs and/or data including information relating to executing acts that carry out acts of the method described in connection with FIG. 4.

Each computer of the computer system can be provided with a display, such as a CRT, LCD, plasma or other such display, and/or input devices, such as a keyboard, mouse and/or trackball for entering information by a user. The display and/or input devices can be coupled to the processor(s) via one or more buses.

A computer-readable medium can comprise any medium that provides instructions to a processor for execution such as non-volatile media, volatile media, and/or transmission media. Examples of a computer-readable medium comprise the memory storage devices discussed above, as well as transmission media such as electromagnetic waves, such as those generated during radio wave and infrared data communications. Computer-readable media can comprise a floppy disk, magnetic medium (such as a hard disk), CD-ROM, RAM, PROM, EPROM, FLASH-EPROM, and/or any other memory chip and/or cartridge.

Various forms of computer readable media can be involved in carrying one or more sequences of one or more instructions to a processor for execution. The remote computer (e.g., server or peer) can load the instructions into its dynamic memory and send the instructions over a network to a local computer (e.g., client or peer). The local computer's communication interface can receive the instructions and/or provide them to the processor(s) of the local computer via one or more buses for execution.

FIG. 4 depicts an exemplary embodiment of a computer implemented method 400. Software can control a computer to perform this method and/or the software can be implemented on a computer readable medium of the type described above. The software can run on a single computer, or multiple computers that are networked. The data received, operated on and generated by the software may be stored in memory (i.e., one or more memory storage devices). The data residing in such memory storage devices may be stored, accessed or manipulated using a database management system, wherein the data is included within a database such as a relational database. The software can control a computer to receive 410 a number of time periods under consideration. The number of time periods can be entered by a user and can be stored in memory, such as one of the memory devices identified above. Thereafter, the software can control the computer to receive 420 a number of expected streams of payments (e.g., royalty payments) received in exchange for transfers of interests in intellectual property assets. The number of expected streams of payments can be entered by a user and can be stored in memory, such as one of the memory devices identified above. The software can control the computer to receive 430 a number of segments to be combined from the total number of expected streams of payments, where each segment is from one of the expected streams of payments and corresponds to a particular time period. The number of segments to be combined can be entered by a user and can be stored in memory, such as one of the memory devices identified above. This step of receiving 430 can facilitate a determination of how many combinations are to be evaluated. By way of example, as described above in the example shown in FIG. 3, the total number of combinations can be determined using the formula: n_C_k=n!/(k!(n−k)!) mentioned above in connection with FIG. 3. In the example described in connection with FIG. 3, n=4 and k=2. As such, there are six possible combinations to evaluate for each time period. However, as noted above, the actual values of n and k can vary as desired

The software can control the computer to receive 440 selected criteria by which combinations of segments are to be evaluated. The selected criteria can be specified by a user and can be stored in memory, such as one of the memory devices identified above. As noted above, it can be desirable to achieve a predictable total stream of payments over the time periods under consideration. One or more criteria can be selected to facilitate that goal. The software can control the computer to determine 450 total number of combinations to be evaluated from the number of segments to be combined as desired.

The software can control the computer to initialize 460 a first array of values to be stored in memory, the values representing segments from the expected streams of payments corresponding to particular time periods. The first array can correspond to a P by S matrix of such values, where P represents the number of periods (e.g., P1, P2, P3) and S represents segments (e.g. S1, S2, S3) from the expected streams of payments corresponding to each period of time. An example of such a matrix is found in the table of FIG. 2B. Thus, the intersection of a particular P (e.g., P1) and a particular S (e.g. Segment 1) represents the value of payment(s) for a particular segment (e.g. Segment 1) of one expected stream of payments corresponding to that time period (e.g., P1).

The software can control the computer to initialize 465 a second array of values to be stored in memory, the values representing total payments associated with combinations of one or more of the above-mentioned segments. The array can correspond to a P by N matrix of such values, where P represents the number of periods (e.g., P1, P2, P3) and N represents the total number of combinations to be evaluated. An example of such a matrix is found in the table reflected in the table of FIG. 3. Thus, the intersection of a particular P (e.g., P1) and a particular N representing a particular combination of segments (e.g., combination of Segment 1 and Segment 2) represents the value of payment(s) corresponding to the total payments associated with those segments for that particular period (e.g., if Segment 1 represented payment(s) of $2 million in period 1 (P1) and Segment 2 represented payment(s) of $2 million in period 1 (P1), the total payment(s) for that combination would be $4 million).

The software can control the computer to initialize 470 a third array of values corresponding to segment identifiers for a particular period that reflect a combination of segments whose corresponding total payment(s) satisfy specified criteria. The array can correspond to a P by I matrix of segment identifiers (e.g. S1, S2, S3) where P represents the number of periods (e.g., P1, P2, P3) and I represents the number of segments in a particular combination.

The software can control the computer to receive values 475 representing segments from the expected streams of payments corresponding to particular time periods in the memory locations corresponding to the first array. These can be user specified values that are entered via a menu driven wizard, and/or they can be stored and/or withdrawn from a file containing those values, such as a database file and/or a spreadsheet file. In some instances, an expected stream of payments can have no payments during a particular time period. A segment associated with an expected can be specified as having a value of zero for the sake of convenience. Alternatively, the value can be specified as undefined and/or any combinations incorporating a segment having an undefined value can be ignored when evaluating those combinations in accordance with specified criteria.

The software can control the computer to calculate 480 the total payments associated with each combination of segments and store them in corresponding memory locations associated with the second array. Exemplary results of such calculations are reflected in FIG. 3.

The software can control the computer to evaluate 485 each of the total payment values (corresponding to each of the combinations of segments for a particular period) in accordance with specified criteria. This step can be done as the total payment values are being calculated or after all such total payment values have been calculated. By way of example, in FIG. 3 the total payment which satisfied the criteria in Period 3 (P3) was $5 million, which corresponded to a combination of Segment 1 and Segment 2.

For each period under consideration, the software can control the computer to store 490 segment identifiers (e.g., Segment 1 and Segment 2) corresponding to the combination whose total payment value satisfies the specified criteria in corresponding memory locations associated with the third array. These identifiers can permit the identification of the corresponding portion of the rights to receive the actual stream of payments in exchange for the transfer of interests in intellectual property assets. By way of example, in FIG. 3 the total payment which satisfied the criteria in Period 3 (P3) was $5 million, which corresponded to a combination of Segment 1 and Segment 2. Thus, segment identifiers S1 and S2 may be stored in the array for Period 3.

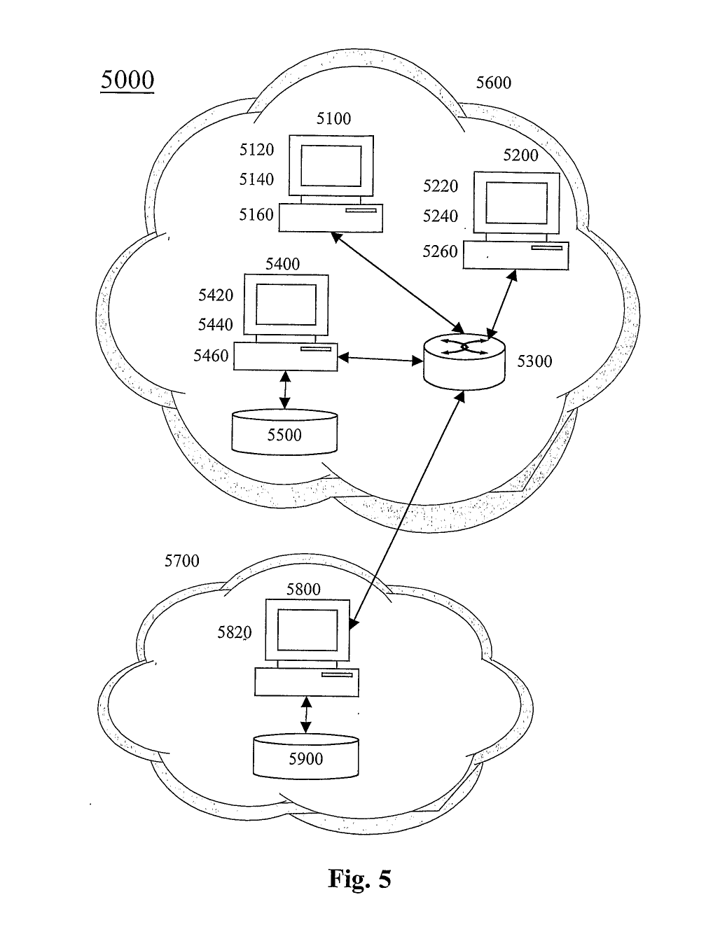

FIG. 5 provides a block diagram of an exemplary embodiment of a system 5000, which can comprise a network 5600 coupled to a network 5700 via a router 5300. Within network 5600, router 5300 can be coupled to other entities, such as information devices 5100, 5200, and/or 5400. Information devices 5100, 5200, 5400 can comprise software applications 5160, 5260, 5460 that provide a user interface 5140, 5240, 5460 to a user 5120, 5220, 5420 of that information device. Any of information devices 5100, 5200, 5400 can store, query, retrieve, relay, and/or report information, such as stream, payment, segment, time period, and/or asset information, etc., via database 5500. Any information device 5100, 5200, 5400 can communicate with a remote information device 5800 residing on and/or within network 5700. Information device 5800 can be coupled to a database 5900.

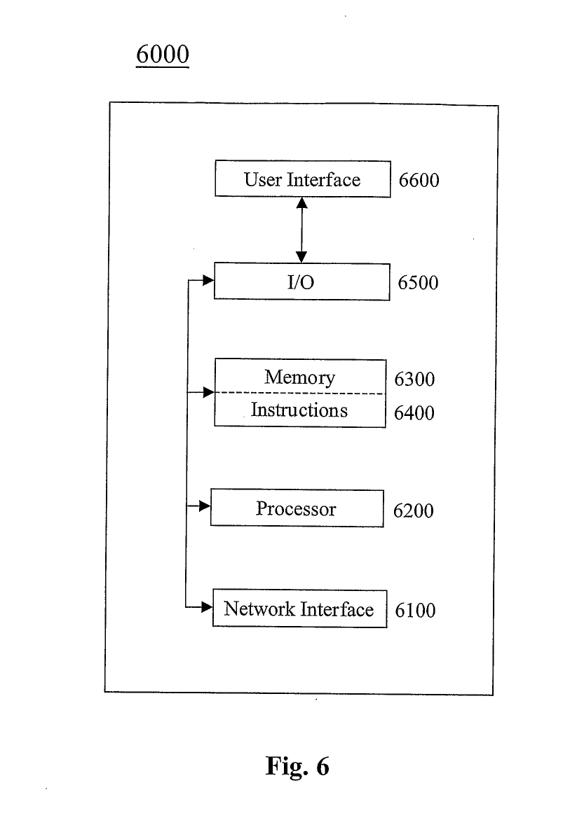

FIG. 6 provides a block diagram of an exemplary embodiment of an information device 6000, which in certain operative embodiments can comprise, for example, any of information devices 5100, 5200, 5400, and/or 5800, etc. of FIG. 5. Information device 6000 can comprise any of numerous well-known components, such as for example, one or more network interfaces 6100, one or more processors 6200, one or more memories 6300 containing instructions 6400, one or more input/output (I/O) devices 6500, and/or one or more user interfaces 6600 coupled to I/O device 6500, etc.

In certain exemplary embodiments, via one or more user interfaces 6600, such as a graphical user interface, a user can view a rendering of, and/or information related to at least one stream, payment, segment, time period, and/or asset, etc.

Still other embodiments will become readily apparent to those skilled in this art from reading the above-recited detailed description and drawings of certain exemplary embodiments. By way of example, the methods described herein can be applied to other intangible assets such as spectrum licenses.

It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A method, comprising:
selecting one or more segments of each of a plurality of streams of expected payments that are to satisfy a plurality of obligations to provide payments to a holder of one or more rights to receive such payments in exchange for transfers of interests in one or more intellectual property assets, said segments corresponding to a first time period having a first duration that is less than a second duration of a second time period over which at least one of the streams of expected payments is expected to extend, wherein said one or more segments are selected such that a first total amount of expected payments associated with said one or more segments satisfies one or more criteria; and
identifying one or more portions of said one or more rights for transfer to an entity, said one or more portions corresponding to the one or more segments that correspond to the first time period, said one or more portions being identified for transfer apart from at least one remaining portion of at least one of said one or more rights.

2. The method defined in claim 1, wherein a plurality of segments of the plurality of streams of expected payments are selected from a plurality of time periods including said first time period, wherein each of said plurality of time periods corresponds to at least one of said plurality of segments, and wherein a plurality of portions of said one or more rights are identified for transfer to an entity, said plurality of portions corresponding to the plurality of segments, said plurality of portions being identified for transfer apart from at least one remaining portion of at least one of said one or more rights.

3. The method defined in claim 1, wherein satisfaction of said one or more criteria requires that the first total amount of expected payments exceed a predetermined amount in said first time period.

4. The method defined in claim 3, wherein satisfaction of said one or more criteria requires that the first total amount of expected payments be closest to said predetermined amount relative to a second total amount of expected payments.

5. The method defined in claim 1, wherein satisfaction of said one or more criteria requires that the first total amount of expected payments fall within a predetermined range of expected payments to be received in said first time period.

6. The method defined in claim 1, further comprising the act of transferring said one or more portions of one or more of said rights to an entity.

7. The method defined in claim 1, wherein said entity is a special purpose vehicle.

8. The method defined in claim 7, wherein said special purpose vehicle is one that facilitates an issuance of securities backed by said one or more portions of one or more of said plurality of rights.

9. The method defined in claim 1, wherein said payments are royalty payments.

10. The method defined in claim 1, wherein said rights are contractual rights.

11. A computer readable medium carrying one or more instructions which, when executed by one or more processors coupled to a memory, cause the one or more processors to carry out the following acts:
selecting one or more segments of each of a plurality of streams of expected payments that are to satisfy a plurality of obligations to provide payments to a holder of one or more rights to receive such payments in exchange for transfers of interests in one or more intellectual property assets, said segments corresponding to a first time period having a first duration that is less than a second duration of a second time period over which at least one of the streams of expected payments is expected to extend, wherein said one or more segments are selected such that a first total amount of expected payments associated with said one or more segments satisfies one or more criteria; and
identifying one or more portions of said one or more rights for transfer to an entity, said one or more portions corresponding to the one or more segments that correspond to the first time period, said one or more portions being identified for transfer apart from at least one remaining portion of at least one of said one or more rights.

12. The computer readable medium defined in claim 11 wherein a plurality of segments of the plurality of streams of expected payments are selected from a plurality of time periods including said first time period, wherein each of said plurality of time periods corresponds to at least one of said plurality of segments, and wherein a plurality of portions of said one or more rights are identified for transfer to an entity, said plurality of portions corresponding to the plurality of segments, said plurality of portions being identified for transfer apart from at least one remaining portion of at least one of said one or more rights.

13. The computer readable medium defined in claim 11, wherein satisfaction of said one or more criteria requires that the first total amount of expected payments exceed a predetermined amount in said first time period.

14. The computer readable medium defined in claim 13, wherein satisfaction of said one or more criteria requires that the first total amount of expected payments be closest to said predetermined amount relative to a second total amount of expected payments.

15. The computer readable medium defined in claim 11, wherein satisfaction of said one or more criteria requires that the first total amount of expected payments fall within a predetermined range of expected payments to be received in said first time period.

16. The computer readable medium defined in claim 11, wherein said payments are royalty payments.

17. The computer readable medium defined in claim 11, wherein said rights are contractual rights.

18. An apparatus comprising one or more processors coupled to a memory storing instructions that are executed by said one or more processors such that said one or more processors select one or more segments of each of a plurality of streams of expected payments that are to satisfy a plurality of obligations to provide payments to a holder of one or more rights to receive such payments in exchange for transfers of interests in one or more intellectual property assets, said segments corresponding to a first time period having a first duration that is less than a second duration of a second time period over which at least one of the streams of expected payments is expected to extend, wherein said one or more segments are selected such that a first total amount of expected payments associated with said one or more segments satisfies one or more criteria; and
identify one or more portions of said one or more rights for transfer to an entity, said one or more portions corresponding to the one or more segments that correspond to the first time period, said one or more portions being identified for transfer apart from at least one remaining portion of at least one of said one or more rights.

19. The apparatus defined in claim 18, wherein a plurality of segments of the plurality of streams of expected payments are selected from a plurality of time periods including said first time period, wherein each of said plurality of time periods corresponds to at least one of said plurality of segments, and wherein a plurality of portions of said one or more rights are identified for transfer to an entity, said plurality of portions corresponding to the plurality of segments, said plurality of portions being identified for transfer apart from at least one remaining portion of at least one of said one or more rights.

20. The apparatus defined in claim 18, wherein satisfaction of said one or more criteria requires that the first total amount of expected payments exceed a predetermined amount in said first time period.

21. The apparatus defined in claim 20, wherein satisfaction of said one or more criteria requires that the first total amount of expected payments be closest to said predetermined amount relative to a second total amount of expected payments.

22. The apparatus defined in claim 18, wherein satisfaction of said one or more criteria requires that the first total amount of expected payments fall within a predetermined range of expected payments to be received in said first time period.

23. The apparatus defined in claim 16, wherein said payments are royalty payments.

24. The apparatus defined in claim 18, wherein said rights are contractual rights.

25. A method, comprising:
for an identified time period, selecting a segment from each of a plurality of expected streams of payments, each expected stream of payments to satisfy at least one obligation to provide payments to a holder of at least one right to receive such payments in exchange for a transfer of at least one interest in at least one an intellectual property asset, each of said segments corresponding to the selected time period, said plurality of segments selected such that a total amount of payments associated with said plurality of segments satisfies one or more predetermined criteria; and
offering to transfer to an entity, an identified portion of said at least one right, said identified portion corresponding to the identified time period, said identified portion distinct from a remaining portion of said at least one obligation.

26. The method of claim 1, further comprising:
determining the time period.

27. The method of claim 1, further comprising:
determining the one or more criteria.

28. The method of claim 1, further comprising:
identifying the portion of said at least one right.

29. The method of claim 1, further comprising:
entering an agreement to transfer the identified portion of said at least one right.

30. The method of claim 1, further comprising:
transferring the identified portion of said at least one right.
